(19) United States
(12) Patent Application Publication
(10) Pub. No.: US 2008/0318543 A1
(43) Pub. Date: Dec. 25, 2008

(54) BASEBAND SIGNAL PROCESSING METHOD, BASEBAND SIGNAL PROCESSING CIRCUIT, AND RECEIVER

(75) Inventor: Tadashi AIZAWA, Matsumoto (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/142,962

(22) Filed: Jun. 20, 2008

(30) Foreign Application Priority Data
Jun. 22, 2007 (JP) 2007-164978

(51) Int. Cl. H04B 1/26

(52) U.S. Cl. 455/314

(57) ABSTRACT

A baseband signal processing method includes reducing a frequency of an intermediate-frequency signal using a first oscillation signal, the intermediate-frequency signal being a signal that has been converted by an RF circuit that converts a received signal into the intermediate-frequency signal using a local oscillation signal, mixing the reduced signal with a second oscillation signal to obtain a baseband signal, and changing the first oscillation signal and the second oscillation signal corresponding to an oscillation frequency of the local oscillation signal.

Japanese Patent Application No. 2007-164978 filed on Jun. 22, 2007, is hereby incorporated by reference in its entirety.

### BACKGROUND

The present invention relates to a baseband signal processing method, a baseband signal processing circuit, and a receiver system.

The global positioning system (GPS) is widely known as a satellite positioning system, and is utilized for a car navigation system and the like. A GPS satellite signal is transmitted from each GPS satellite that orbits the earth. A GPS receiver calculates (locates) its present position based on the GPS satellite signals received from the GPS satellites.

A GPS module provided in the GPS receiver includes an RF receiver circuit and a baseband signal processing circuit. The GPS module generally receives a GPS signal using a superheterodyne method. Specifically, the RF receiver circuit synthesizes the received signal with an oscillation signal having a given frequency to convert the received signal into an intermediate-frequency signal (IF signal). The baseband signal processing circuit down-converts the IF signal input from the RF receiver circuit to obtain a baseband signal. The baseband signal processing circuit then acquires and tracks the GPS satellite signal included in the received signal, and decodes a navigation message included in the GPS satellite signal. The baseband signal processing circuit calculates the pseudo-range based on orbit information and time information relating to the GPS satellite included in the decoded navigation message, and calculates the present position.

Since the GPS satellite signal (frequency: 1.57542 GHz) is converted into a low-frequency IF signal, a signal having a frequency of about 1.5 GHz is used as the oscillation signal synthesized with the received signal. The oscillation signal is generated by a given local oscillator. In order to control the oscillation frequency of the local oscillator to be a constant value, a PLL circuit that receives a reference signal (synchronization signal) having a constant frequency with a small variation from the outside and controls the oscillation frequency to be a constant value is generally provided in the RF receiver circuit. Specifically, the PLL circuit is set and configured corresponding to the frequency of the reference signal so that a local oscillator generates an oscillation signal having a given oscillation frequency.

On the other hand, the GPS module is provided in various electronic instruments regardless of the manufacturer and the model. Therefore, the frequency of the reference signal input to the RF receiver circuit of the GPS module differs depending on the electronic instrument in which the GPS module is incorporated. This makes it necessary to produce an RF receiver circuit while changing the configuration of a PLL circuit corresponding to the reference signal. In recent years, an RF receiver circuit that can deal with a plurality of reference signals differing in frequency has been developed (see data sheet “NJ1006A GPS Receiver RF Front-End IC”, Nemerix, September, 2005, Rev. 1.5).

Specifically, an RF receiver circuit (i.e., an element of a GPS module) that can deal with a plurality of reference signals differing in frequency is known. However, if the frequency of the IF signal output from the RF receiver circuit changes corresponding to the reference signal, the baseband signal processing circuit also must appropriately deal with different IF frequencies. Specifically, it is desirable that the entire GPS module deal with a plurality of types of reference signals rather than only the RF receiver circuit being able to deal with different reference frequencies.

### SUMMARY

According to one aspect of the invention, there is provided a baseband signal processing method comprising reducing a frequency of an intermediate-frequency signal using a first oscillation signal, the intermediate-frequency signal being a signal that has been converted by an RF circuit that converts a received signal into the intermediate-frequency signal using a local oscillation signal, mixing the reduced signal with a second oscillation signal to obtain a baseband signal, and changing the first oscillation signal and the second oscillation signal corresponding to an oscillation frequency of the local oscillation signal.

### BRIEF DESCRIPTION OF THE SEVERAL VIEWS OF THE DRAWING

FIG. 1 is an internal configuration diagram showing a portable telephone.

FIG. 2 is a circuit configuration diagram showing an RF receiver circuit section and a baseband process circuit section.

FIG. 3A shows a frequency setting example for the RF receiver circuit section corresponding to a reference frequency, and FIG. 3B shows a frequency setting example for the baseband process circuit section corresponding to a reference frequency.

### DESCRIPTION OF EXEMPLARY EMBODIMENTS

The invention may enable the entire system (e.g., GPS module) to deal with a plurality of types of reference signals.

One embodiment of the invention relates to a baseband signal processing circuit comprising a down-converter that reduces the frequency of an output signal from an RF circuit based on a first oscillation signal and outputs the resulting signal, the RF circuit converting the frequency of a received signal into an intermediate frequency signal corresponding to an oscillation frequency of a local oscillation signal by mixing the local oscillation signal with the received signal, the oscillation frequency of the local oscillation signal being variable, a first oscillation signal generator that generates the first oscillation signal at an oscillation frequency corresponding to the oscillation frequency of the local oscillation signal, a carrier signal synchronization section that generates a second oscillation signal based on an output signal from the down-converter, the second oscillation signal being synchronized with at least one of the frequency and the phase of the output signal, and a detector that obtains a baseband signal by mixing the second oscillation signal obtained by the carrier signal synchronization section with the output signal from the down-converter.

Another embodiment of the invention relates to a baseband signal processing method comprising down-converting the frequency of an output signal from an RF circuit based on a first oscillation signal, the RF circuit converting the frequency of a received signal into an intermediate frequency signal corresponding to an oscillation frequency of a local oscillation signal by mixing the local oscillation signal with the received signal, the oscillation frequency of the local oscillation signal being variable, generating the first oscillation signal at an oscillation frequency corresponding to the oscillation frequency of the local oscillation signal, generating a second oscillation signal based on the down-converted signal, the second oscillation signal being synchronized with at least one of the frequency and the phase of the down-converted signal, and obtaining a baseband signal by mixing the second oscillation signal with the down-converted signal.

This implements a baseband signal processing circuit that down-converts the output signal from the RF circuit based on the first oscillation signal and obtains the baseband signal by mixing the second oscillation signal with the down-converted signal. The output signal from the RF circuit is an IF signal of which the frequency has been converted into an intermediate frequency corresponding to the oscillation frequency of the local oscillation signal by mixing the local oscillation signal with the received signal. Specifically, the frequency of the IF signal differs corresponding to the oscillation frequency of the local oscillation signal. Since the first oscillation signal used for down conversion is generated corresponding to the oscillation frequency of the local oscillation signal mixed into the received signal, the down-converted signal has a frequency corresponding to the oscillation frequency of the local oscillation signal. The second oscillation signal used to obtain the baseband signal is generated as a signal that is synchronized with at least one of the frequency and the phase of the down-converted signal. Specifically, the first and second oscillation signals are generated as signals having frequencies corresponding to the oscillation frequency of the local oscillation signal. This implements a baseband signal processing circuit that can obtain the baseband signal from a plurality of types of IF signals differing in frequency.

In the above baseband signal processing circuit, the carrier signal synchronization section may generate the second oscillation signal while changing the oscillation frequency corresponding to the oscillation frequency of the local oscillation signal.

According to this configuration, the second oscillation signal used to obtain the baseband signal is generated corresponding to the oscillation frequency of the local oscillation signal.

In the above baseband signal processing circuit, the received signal may be a positioning signal transmitted from a positioning satellite; the detectormay obtain a pseudo random noise (PRN) code included in the positioning signal as the baseband signal; and the baseband signal processing circuit may further include: a correlator that calculates a correlation between the PRN code obtained by the detector and a code replica of the PRN code; an acquisition section that acquires the positioning signal transmitted from the positioning satellite based on a correlation result obtained by the correlator ; and a positioning calculator that calculates a present position based on the positioning signal acquired by the acquisition section.

This makes it possible to receive the positioning signal transmitted from the positioning satellite and obtain the PRN code included in the received positioning signal as the baseband signal to calculate the present position. Specifically, the baseband signal processing circuit can be applied to a positioning system (e.g., GPS receiver) that receives a positioning signal transmitted from a positioning satellite and calculates the present position.

Another embodiment of the invention relates to a receivercomprising an RF circuit that converts the frequency of a received signal into an intermediate frequency corresponding to an oscillation frequency of a local oscillation signal by mixing the local oscillation signal with the received signal, and outputs the resulting signal, the oscillation frequency of the local oscillation signal being variable, and the above baseband signal processing circuit.

This implements a receiver that includes an RF circuit that converts the frequency of the received signal into an intermediate frequency signal corresponding to the oscillation frequency of the local oscillation signal by mixing the local oscillation signal with the received signal, and outputs the resulting signal, and a baseband signal processing circuit that obtains the baseband signal from the signal output from the RF circuit. The frequency of the signal (IF signal) output from the RF circuit differs corresponding to the oscillation frequency of the local oscillation signal mixed into the received signal. The baseband signal processing circuit generates the first and second oscillation signals at frequencies corresponding to the oscillation frequency of the local oscillation signal used in the RF circuit. This implements a receiver in which the entire system including the RF circuit and the baseband signal processing circuit can deal with a plurality of types of local oscillation signals, differing from a related-art system in which only the RF circuit can deal with a plurality of types of local oscillation signals.

The above receiver may further include a switch instruction signal generation circuit that generates a switch instruction signal, the RF circuit may generate the local oscillation signal while selecting the oscillation frequency from a plurality of oscillation frequencies specified in advance according to the switch instruction signal generated by the switch instruction signal generation circuit, and the first oscillation signal generator may generate the first oscillation signal while selecting the oscillation frequency from a plurality of oscillation frequencies specified in advance according to the switch instruction signal generated by the switch instruction signal generation circuit.

According to this configuration, each of the local oscillation signal used in the RF circuit and the first oscillation signal used in the baseband signal processing circuit are generated while selecting the oscillation frequency from the oscillation frequencies specified in advance according to the switch instruction signal generated by the switch instruction signal generation circuit.

Preferred embodiments of the invention are described below with reference to the drawings. The following embodiments illustrate an example in which the invention is applied to a portable telephone having a GPS positioning function. Note that embodiments to which the invention may be applied are not limited to the following embodiments.

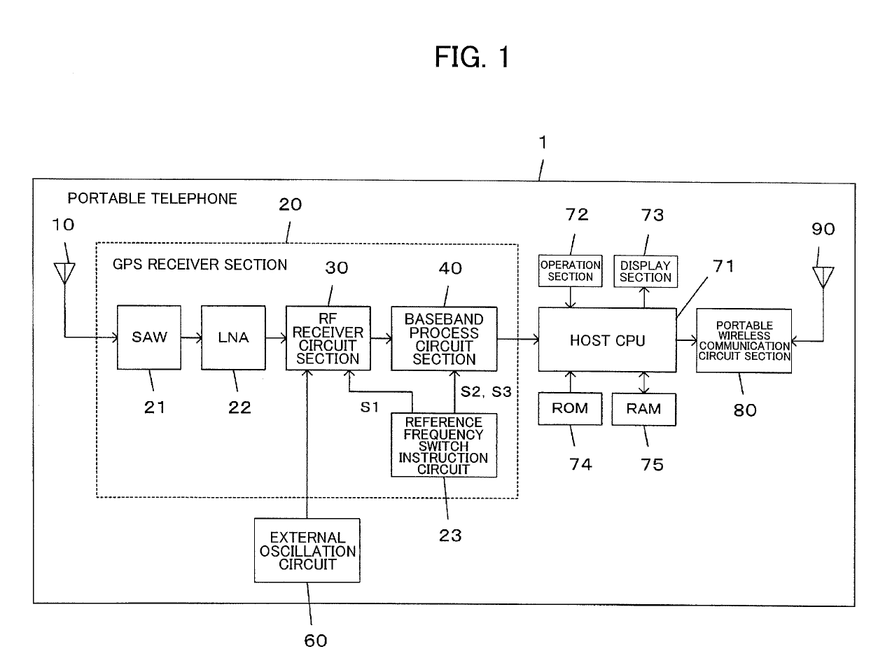

FIG. 1 is a block diagram showing the internal configuration of a portable telephone 1 according to one embodiment of the invention. As shown in FIG. 1, the portable telephone 1 has a GPS positioning function, and includes a GPS antenna 10, a GPS receiver section (GPS receiver system) 20, an external oscillation circuit 60, a host central processing unit (CPU) 71, an operation section 72, a display section 73, a read-only memory (ROM) 74, a random access memory (RAM) 75, a portable wireless communication circuit section 80, and a portable antenna 90.

The GPS antenna 10 is an antenna that receives an RF signal including a GPS satellite signal transmitted from a GPS satellite.

The GPS receiver section 20 acquires/extracts the GPS satellite signal from the RF signal received by the GPS antenna 10, and calculates the present position of the portable telephone 1 by performing positioning calculations based on a navigation message extracted from the GPS satellite signal and the like. The GPS receiver section 20 includes a surface acoustic wave (SAW) filter 21, a low-noise amplifier (LNA) 22, a radio frequency (RF) receiver circuit section 30, a baseband process circuit section 40, and a reference frequency switch instruction circuit 23. The RF receiver circuit section 30 and the baseband process circuit section 40 of the GPS receiver section 20 may be produced as different large scale integrated (LSI) circuits, or may be produced in one chip. The entire GPS receiver section 20 including the SAW filter 21 and the LNA 22 may be produced in one chip.

The SAW filter 21 is a bandpass filter. The SAW filter 21 allows a given band component (signal) of the RF signal input from the GPS antenna 10 to pass through while blocking a frequency component outside the given band, and outputs the resulting signal. The LNA (low-noise amplifier) 22 amplifies the signal input from the SAW filter 21, and outputs the amplified signal.

The RF receiver circuit section 30 multiplies (syntliesizes) the signal (RF signal) input from the LNA 22 by a signal (local oscillation signal) generated based on a reference signal REF input from the external oscillation circuit 60 to down-convert the signal input from the LNA 22 into an intermediate-frequency (IF) signal. The RF receiver circuit section 30 then converts the IF signal into a digital signal, and outputs the resulting digital signal. The RF receiver circuit section 30 down-converts the input RF signal into an IF signal having a given intermediate frequency according to a switch instruction signal S1 input from the reference frequency switch instruction circuit 23.

The baseband process circuit section 40 acquires/tracks the GPS satellite signal from the IF signal input from the RF receiver circuit section 30, and performs pseudo-range calculations, positioning calculations, and the like based on a navigation message, time information, and the like extracted by decoding the data contained in the GPS satellite signal. The baseband process circuit section 40 converts the input IF signal into a baseband signal while switching the oscillation frequency of an oscillator included in the baseband process circuit section 40 according to switch instruction signals S2 and S3 input from the reference frequency switch instruction circuit 23.

The external oscillation circuit 60 is a crystal oscillator, for example. The external oscillation circuit 60 generates and outputs the reference signal REF having a given oscillation frequency. The oscillation frequency of the reference signal REF generated by the external oscillation circuit 60 differs depending on the manufacturer and the model of the portable telephone 1. Therefore, the GPS receiver section 20 is configured to deal with a plurality of types of reference signals REF.

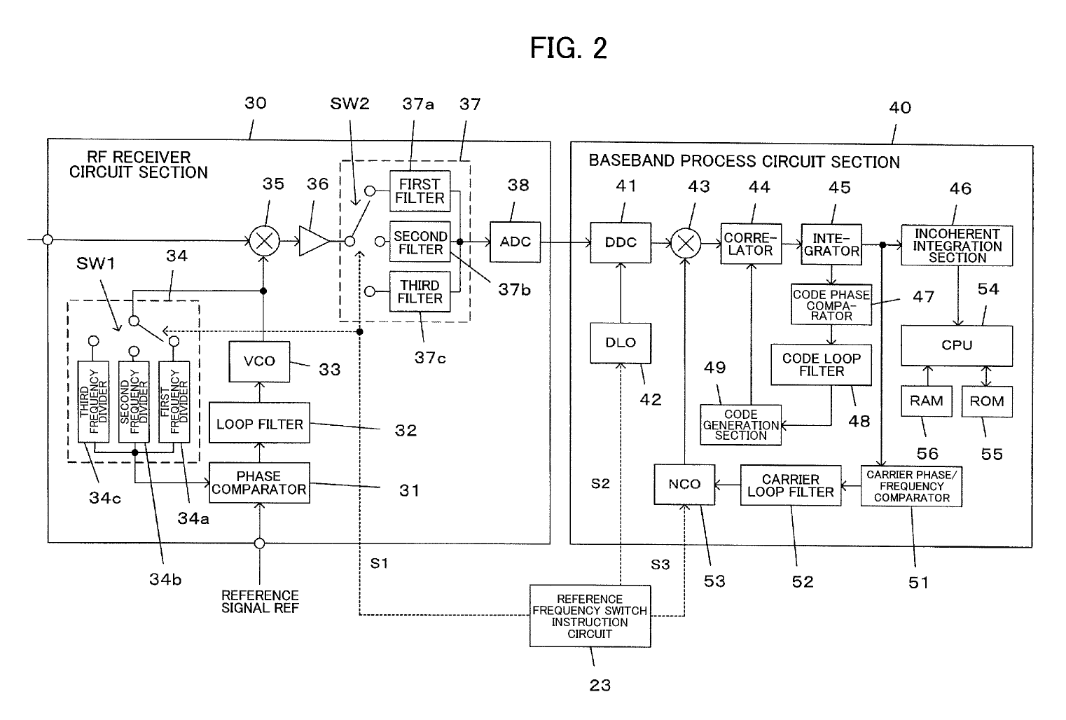

FIG. 2 is a view showing a detailed circuit configuration of the RF receiver circuit section 30 and the baseband process circuit section 40. As shown in FIG. 2, the RF receiver circuit section 30 includes a phase comparator 31, a loop filter 32, a voltage-controlled oscillator (VCO) 33, a frequency divider group 34, a mixer 35, an amplifier 36, a filter group 37, and an analog-to-digital (A/D) converter (ADC) 38.

The phase comparator 31, the loop filter 32, the VCO 33, and the frequency divider group 34 form a phase locked loop (PLL) circuit. The PLL circuit compares and synchronizes a signal obtained by dividing (reducing) the frequency of a VCO oscillation signal (local oscillation signal) with the reference signal REF that serves as a synchronization signal to generate a stable local oscillation signal.

Specifically, the frequency divider group 34 divides the frequency of the VCO oscillation signal generated by the VCO 33 so that the VCO oscillation signal has the same frequency as that of the reference signal REF, and the phase comparator 31 calculates the phase difference between the reference signal REF and the VCO oscillation signal of which the frequency has been divided by the frequency divider group 34. The loop filter 32 converts a phase difference signal input from the phase comparator 31 into a direct-current signal containing only a direct-current component. The VCO (voltage-controlled oscillator) 33 generates a signal (VCO oscillation signal) having a frequency corresponding to the phase difference signal input through the loop filter 32.

The frequency divider group 34 includes a first frequency divider 34a, a second frequency divider 34b, a third frequency divider 34c, and a switch SWI, the first frequency divider 34a, the second frequency divider 34b, and the third frequency divider 34c differing in frequency division ratio. In order to reduce the frequency of the VCO oscillation signal so that the VCO oscillation signal has the same frequency as that of each of a plurality of (three in this embodiment) types of reference signals REF, the frequency dividers 34a to 34c are provided corresponding to the respective reference signals REF. The switch SW1 is connected to one of the frequency dividers 34a to 34c according to the switch instruction signal S1 input from the reference frequency switch instruction circuit 23. Specifically, the frequency divider group 34 switches the frequency divider according to the switch instruction signal SI, divides the frequency of the VCO oscillation signal generated by the VCO 33, and outputs the resulting signal.

The mixer 35 multiplies (synthesizes) the signal (RF signal) input from the LNA 22 by the VCO oscillation signal generated by the VCO 33 to generate an IF signal. The amplifier 36 amplifies the IF signal input from the mixer 35, and outputs the resulting signal.

The filter group 37 includes a first filter 37a, a second filter 37b, a third filter 37c, and a switch SW2, the first filter 37a, the second filter 37b, and the third filter 37c differing in passband W. The IF frequency of the IF signal differs corresponding to each of a plurality of (three in this embodiment) types of reference signals REF. In order to extract a frequency range appropriate for the performance of the ADC 38 from the IF signal, taking into account the IF frequency that differs corresponding to each of the reference signals REF and the resolution of the ADC 38, the filters 37a to 37c are provided corresponding to the respective reference signals REF. The switch SW2 is connected to one of the filters 37a to 37c according to the switch instruction signal S1 input from the reference frequency switch instruction circuit 23. The switch instruction signal S1 is the same as the switching signal S1 input to the switch SW1.

The ADC (A/D converter) 38 converts the IF signal (analog signal) input through the filter group 37 into a digital signal, and outputs the resulting digital signal. The output signal from the ADC 38 is output from the RF receiver circuit section 30 as the IF signal.

As described above, the RF receiver circuit section 30 synthesizes the input RF signal with the VCO oscillation signal to convert the RF signal into an IF signal, and outputs the IF signal. The frequency of the VCO oscillation signal generated by the VCO 33 differs corresponding to the frequency (reference frequency) of the input reference signal REF. Therefore, the frequency of the IF signal generated by the RF receiver circuit section 30 differs corresponding to the frequency of the reference signal REF.

As shown in FIG. 2, the baseband process circuit section 40 includes a digital down-converter (DDC) 41, a digital local oscillator (DLO) 42, a mixer 43, a correlator 44, an integrator 45, an incoherent integration section 46, a code phase comparator 47, a code loop filter 48, a code generation section 49, a carrier phase/frequency comparator 51, a carrier loop filter 52, a numerical controlled oscillator (NCO) 53, a CPU 54, a ROM 55, and a RAM 56.

The DDC (digital down-converter) 41 multiplies (synthesizes) the IF signal input from the RF receiver circuit section 30 by an oscillation signal (first oscillation signal) input from the DLO 42 to down-convert (reduce) the frequency of the IF signal. The DLO 42 generates the oscillation signal (first oscillation signal) while changing the oscillation frequency of the oscillation signal according to the switch instruction signal S2 input from the reference frequency switch instruction circuit 23. The mixer 43 multiplies (synthesizes) the signal input from the DDC 41 by an oscillation signal (second oscillation signal) input from the NCO 53 to convert the signal input from the DDC 41 into a baseband signal in which a C/A code is modulated by a navigation message. Specifically, the mixer 43 serves as a detector.

The correlator 44 multiplies (synthesizes) the signal (baseband signal) input from the mixer 43 by a code replica input from the code generation section 49 to calculate a correlation value. The integration section 43 integrates the correlation values input from the correlator 44. The incoherent integration section 46 performs an incoherent integration process on the integrated correlation values input from the integrator 45. Specifically, the incoherent integration section 46 integrates the absolute values (magnitude) of the integrated correlation values input from the integrator 45. The incoherent integration section 46 outputs the integrated value to the CPU 54 at given positioning intervals (e.g., intervals of one second).

The code phase comparator 47, the code loop filter 48, and the code generation section 49 form a delay locked loop (DLL) to form a code loop circuit that tracks the phase of a C/A code. Specifically, the code phase comparator 47 calculates the phase difference between the C/A code and the code replica included in the signal input from the integrator 45. The code loop filter 48 converts a phase difference signal input from the code phase comparator 47 into a direct-current signal containing only a direct-current component. The code generation section 49 generates a code replica having a given frequency and a given phase according to a control signal input from the CPU 54, and adjusts the phase of the code replica according to the phase difference signal input through the code loop filter 48.

The carrier phase/frequency comparator 51, the carrier loop filter 52, and the NCO 53 form a delay locked loop (DLL) that tracks the phase of a carrier frequency and a frequency locked loop (FLL) that tracks the frequency to form a carrier loop circuit. Specifically, the carrier phase/frequency comparator 51 calculates the phase difference and the frequency difference between the output signal from the DDC 41 and the oscillation signal (second oscillation signal) from the NCO 53 based on the signal input from the integrator 45. The carrier loop filter 52 converts a phase/frequency difference signal input from the carrier phase/input frequency comparator 51 into a direct-current signal containing only a direct-current component. The NCO 53 generates the oscillation signal (second oscillation signal) while changing the oscillation frequency of the oscillation signal according to the switch instruction signal S3 input from the reference frequency switch instruction circuit 23, and adjusts the phase/frequency of the oscillation signal according to the phase/frequency difference signal input through the carrier loop filter 52.

The CPU 54 controls each section of the baseband process circuit section 40, and performs various calculations including a baseband process. In the baseband process, the CPU 54 specifies a GPS satellite signal, and acquires and tracks a GPS satellite signal based on the integrated value obtained by the incoherent integration process performed by the incoherent integration section 46. The CPU 54 extracts a navigation message by decoding data contained in each GPS satellite signal that has been tracked, and performs pseudo-range calculations, positioning calculations, and the like to locate the present position. The CPU 54 controls the code generation section 49 to generate a code replica corresponding to the acquisition target GPS satellite signal while changing the signal frequency and the phase of the code replica. This makes it possible to acquire and track a GPS satellite signal based on the integrated value output from the incoherent integration section 46. The CPU 54 causes the reception frequency of the GPS satellite signal to coincide with the frequency of the code replica signal and causes the phase of the C/A code contained in the received GPS satellite signal to coincide with the phase of the code replica based on the integrated value output from the incoherent integration section 46 and the like.

The ROM 55 stores a system program that causes the CPU 54 to control each section of the baseband process circuit section 40 and the RF receiver circuit section 30, various programs and data necessary for implementing various processes including the baseband process, and the like.

The RAM 56 is used as a work area for the CPU 54. The RAM 56 temporarily stores a program and data read from the ROM 55, calculations results of the CPU 54 based on various programs, and the like.

The reference frequency switch instruction circuit 23 is a circuit that changes various settings of the RF receiver circuit section 30 and the baseband process circuit section 40 corresponding to the oscillation frequency (reference frequency) of the reference signal REF generated by the external oscillation circuit 60. Specifically, the reference frequency switch instruction circuit 23 outputs the switch instruction signals SI to S3 associated with the reference frequencies according to a predetermined correspondence relationship. The GPS receiver section 20 is a module (system) provided in the portable telephone 1. Therefore, the reference frequency of the reference signal REF generated outside the GPS receiver section 20 is not determined by the GPS receiver section 20, but is determined depending on the portable telephone 1. The signal output from the reference frequency switch instruction circuit 23 is changed and set corresponding to the reference frequency of the reference signal REF of the portable telephone 1 during production of the portable telephone 1 including the GPS receiver section 20 or during production of the GPS receiver section 20 after the portable telephone 1 in which the GPS receiver section 20 is to be incorporated has been determined. For example, a given terminal of the GPS receiver section 20 that has been incorporated in a module or an IC chip may be used as a change/setting terminal for the reference frequency switch instruction circuit 23, and the signal output from the reference frequency switch instruction circuit 23 may be changed and set by changing a voltage applied to the terminal (or a combination of voltages applied to a plurality of terminals).

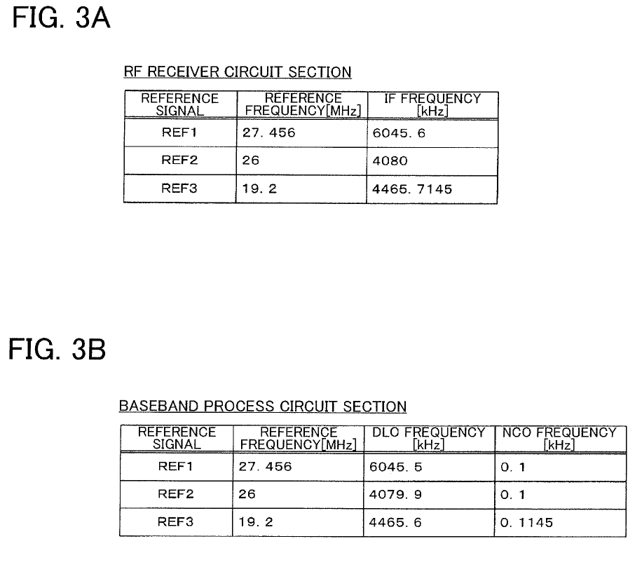

FIGS. 3A and 3B show setting examples when three types of reference signals REF1 to REF3 can be utilized. FIG. 3A shows a setting example of the RF receiver circuit section 30. FIG. 3A shows the frequencies (reference frequencies) of the reference signals REF1 to REF3 and the frequency (IF frequency) of the IF signal generated corresponding to each of the reference signals REF1 to REF3. Specifically, the oscillation frequency of the VCO 33 of the RF receiver circuit section 30 differs corresponding to the frequency (reference frequency) of the reference signal REF. Therefore, the frequency (IF frequency) of the IF signal differs corresponding to the frequency of the reference signal REF. The switch instruction signal S1 is set so that the connection target frequency divider of the frequency divider group 34 is changed corresponding to the oscillation frequency of the VCO 33, and the connection target filter of the filter group 37 is changed to a filter having a passband corresponding to the IF frequency.

FIG. 3B shows a setting example of the baseband process circuit section 40. FIG. 3B shows the frequencies (reference frequencies) of the reference signals REF1 to REF3 and the oscillation frequencies of the DLO 42 and the NCO 53. In the baseband process circuit section 40, the DDC 41 synthesizes the IF signal input from the RF receiver circuit section 30 with the oscillation signal input from the DLO 42 to down-convert the IF signal, and the mixer 43 synthesizes the down-converted signal with the oscillation signal input from the NCO 53 to generate a baseband signal. The frequency of the IF signal input to the baseband process circuit section 40 differs corresponding to the reference frequency, as shown in FIG. 3A. Specifically, the oscillation frequencies of the oscillation signals output from the DLO 42 and the NCO 53 synthesized with the IF signal differ corresponding to the frequency of the IF signal. Therefore, the switch instruction signals S2 and S3 are set so that the oscillation frequencies of the DLO 42 and the NCO 53 are changed to frequencies corresponding to the frequency (IF frequency) of the input IF signal.

For example, when the frequency (reference frequency) of the reference signal REF1 is 27.456 MHz, the oscillation frequency (DLO frequency) of the DLO 42 is set at 6045.5 kHz, and the oscillation frequency (NCO frequency) of the NCO 53 is set at 0.1 kHz. In this case, the frequency of the IF signal input to the baseband process circuit section 40 is 6045.6 kHz. The IF signal is synthesized by the DDC 41 with the oscillation signal having a frequency of 6045.5 kHz to obtain a signal having a frequency of 0.1 (=6045.6−6045.5) KHz. The resulting signal is synthesized by the mixer 43 with the oscillation signal having a center frequency of 0.1 kHz to obtain a baseband signal.

Again referring to FIG. 1, the host CPU 71 controls each section of the portable telephone 1 based on various programs such as the system program stored in the ROM 74. Specifically, the host CPU 71 mainly implements a telephone call function, and also performs a process that implements various functions including a navigation function such as causing the display section 73 to display a navigation screen in which the present position of the portable telephone 1 input from the baseband process circuit section 40 is plotted on a map.

The operation section 72 is an input device including an operation key, a button switch, and the like. The operation section 72 outputs an operation signal corresponding to the operation of the user to the host CPU 71. Various instructions such as a positioning start/finish instruction are input by operating the operation section 72. The display section 73 is a display device such as a liquid crystal display (LCD). The display section 73 displays a display screen (e.g., navigation screen and time information) based on a display signal input from the host CPU 71.

The ROM 74 stores a system program that causes the host CPU 71 to control the portable telephone 1, a program and data necessary for implementing a navigation function, and the like. The RAM 75 is used as a work area for the host CPU 71. The RAM 75 temporarily stores a program and data read from the ROM 74, operation data input from the operation section 72, calculation results of the host CPU 71 based on various programs, and the like.

The portable wireless communication circuit section 80 is a portable telephone communication circuit section that includes an RF conversion circuit, a baseband process circuit, and the like. The portable wireless communication circuit section 80 transmits and receives radio signals under control of the host CPU 71. The portable antenna 90 is an antenna that transmits and receives portable telephone radio signals between the portable telephone 1 and a radio base station installed by a communication service provider of the portable telephone 1. Note that the portable wireless communication circuit section 80 and the like also utilize the reference signal REF generated by the external oscillation circuit 60.

Effects

According to this embodiment, the RF receiver circuit section 30 of the GPS receiver section 20 synthesizes the received signal with the oscillation signal (VCO oscillation signal) generated by the VCO 33 so that the received signal is converted into an IF signal and then output. Since a VCO oscillation signal having a frequency corresponding to the frequency (reference frequency) of the reference signal REF is generated, the frequency (IF frequency) of the IF signal differs corresponding to the frequency of the reference signal REF. The baseband process circuit section 40 synthesizes the input IF signal with the oscillation signal generated by the DLO 42 to down-convert the IF signal, and synthesizes the down-converted signal with the oscillation signal generated by the NCO 53 to obtain a baseband signal. The reference frequency switch instruction circuit 23 outputs the switch instruction signals S1 to S3 corresponding to the frequency (reference frequency) of the reference signal REF according to a predetermined correspondence relationship to change the connections of the frequency divider group 34 and the filter group 37 of the RF receiver circuit section 30 and change the oscillation frequencies of the DLO 42 and the NCO 53 of the baseband process circuit section 40. This implements a GPS receiver section 20 that can deal with a plurality of basic frequencies.

Modification

Embodiments to which the invention may be applied are not limited to the above-described embodiments. Various modifications and variations may be made without departing from the spirit and scope of the invention.

A. Receiver System

The above embodiments have been described taking an example of a portable telephone including a GPS receiver system. Note that the invention may also be applied to other electronic instruments such as a portable navigation system, a car navigation system, a personal digital assistant (PDA), and a wristwatch.

B. Satellite Positioning System

The above embodiments have been described taking an example utilizing the GPS. Note that the invention may also be applied to other satellite positioning systems such as the global navigation satellite system (GLONASS).

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A baseband signal processing method comprising:
reducing a frequency of an intermediate-frequency signal using a first oscillation signal, the intermediate-frequency signal being a signal that has been converted by an RF circuit that converts a received signal into the intermediate-frequency signal using a local oscillation signal,
mixing the reduced signal with a second oscillation signal to obtain a baseband signal, and
changing the first oscillation signal and the second oscillation signal corresponding to an oscillation frequency of the local oscillation signal.

2. The baseband signal processing method as defined in claim 1,
the frequency of the local oscillation signal being variable; and
the method including:
generating the first oscillation signal at an oscillation frequency corresponding to the oscillation frequency of the local oscillation signal;
down-converting the frequency of the intermediate-frequency signal using the first oscillation signal;
generating the second oscillation signal to be synchronized with at least one of the frequency and the phase of the down-converted signal; and
obtaining the baseband signal by mixing the second oscillation signal with the down-converted signal.

3. The baseband signal processing method as defined in claim 2,
the generating of the second oscillation signal including generating the second oscillation signal while changing an oscillation frequency of the second oscillation signal to be synchronized with at least one of the frequency and the phase of the down-converted signal based on the oscillation frequency of the local oscillation signal.

4. The baseband signal processing method as defined in claim 2,
the received signal being a positioning signal transmitted from a positioning satellite;
the obtaining of the baseband signal including obtaining a pseudo random noise (PRN) code included in the positioning signal as the baseband signal; and
the method further including:
correlating between the obtained PRN code and a code replica of the PRN code;
acquiring the positioning signal transmitted from the positioning satellite based on the calculated correlation result; and
calculating a present position based on the acquired positioning signal.

5. A baseband signal processing circuit comprising:
a frequency reducer that reduces a frequency of an intermediate-frequency signal using a first oscillation signal, the intermediate-frequency signal being a signal that has been converted by an RF circuit that converts a received signal into the intermediate-frequency signal using a local oscillation signal, and
a signal mixer that mixes the reduced signal with a second oscillation signal to obtain a baseband signal, wherein
the baseband signal processing circuit is capable of changing the first oscillation signal and the second oscillation signal corresponding to an oscillation frequency of the local oscillation signal.

6. The baseband signal processing circuit as defined in claim 5,
the frequency of the local oscillation signal being variable; and
the baseband signal processing circuit including:
a first oscillation signal generator that generates the first oscillation signal at an oscillation frequency corresponding to the oscillation frequency of the local oscillation signal;
a down-converter that down-converts the frequency of the intermediate-frequency signal using the first oscillation signal;
a second oscillation signal generator that generates the second oscillation signal to be synchronized with at least one of the frequency and the phase of an output signal from the down-converter; and
a detector that obtains the baseband signal by mixing the second oscillation signal with the output signal from the down-converter.

7. The baseband signal processing circuit as defined in claim 6,
the second oscillation signal generator generating the second oscillation signal while changing an oscillation frequency of the second oscillation signal to be synchronized with at least one of the frequency and the phase of the output signal from the down-converter based on the oscillation frequency of the local oscillation signal.

8. The baseband signal processing circuit as defined in claim 6,
the received signal being a positioning signal transmitted from a positioning satellite;
the detector obtaining a pseudo random noise (PRN) code included in the positioning signal as the baseband signal; and
the baseband signal processing circuit further including:
a correlator that calculates a correlation between the PRN code obtained by the detector and a code replica of the PRN code;
an acquisition section that acquires the positioning signal transmitted from the positioning satellite based on a correlation result obtained by the correlator; and
a positioning calculator that calculates a present position based on the positioning signal acquired by the acquisition section.

9. A receiver comprising:
the RF circuit; and
the baseband signal processing circuit as defined in claim 6.

10. The receiver as defined in claim 9,
the receiver further including a switch instruction signal generator that generates a switch instruction signal,
the RF circuit generating the local oscillation signal while selecting the oscillation frequency from a plurality of oscillation frequencies specified in advance according to the switch instruction signal generated by the switch instruction signal generator; and
the first oscillation signal generator generating the first oscillation signal while selecting the oscillation frequency from a plurality of oscillation frequencies specified in advance according to the switch instruction signal generated by the switch instruction signal generator.
